(19) United States
(12) Patent Application Publication
(10) Pub. No.: US 2025/0196476 A1
(43) Pub. Date: Jun. 19, 2025

(54) COMPOSITION FOR VULCANIZATION BONDING, COMPOSITIONS FOR VULCANIZATION-BONDED LAMINATE, AND LAMINATE OBTAINED FROM SAID COMPOSITIONS

(71) Applicant: OSAKA SODA CO., LTD., Osaka-shi, Osaka (JP)

(72) Inventors: Taro OZAKI, Osaka (JP); Naoya YAJIMA, Osaka (JP); Motoki KITAGAWA, Osaka (JP); Masatsugu NAITOU, Osaka (JP)

(21) Appl. No.: 18/845,268

(22) PCT Filed: Mar. 24, 2023
(86) PCT No.: PCT/JP2023/011853

§ 371 Date: Sep. 9, 2024

(30) Foreign Application Priority Data
Mar. 31, 2022 (JP) 2022-061409

(51) Int. Cl. B32B 25/04; B32B 1/08; B32B 25/14; B32B 38/00

(52) U.S. Cl. CPC B32B 25/042; B32B 1/08; B32B 25/14; B32B 2038/0076; B32B 2250/02; B32B 2250/248; B32B 2305/72; B32B 2319/00; B32B 2597/00

(57) ABSTRACT

The present invention aims to provide a composition for a vulcanization-bonded laminate in which an epichlorohydrin rubber can be strongly bonded to a fluororubber, as well as a laminate produced from the composition. It has been found that a composition for a vulcanization-bonded laminate which includes a rubber layer (A) formed from a vulcanization bonding composition at least containing an epihalohydrin rubber, a hydroxyl group-free tri- to penta-functional acrylate, an epoxy resin, nickel dibutyldithiocarbamate, and a vulcanizing agent, and a fluororubber layer (B) formed from a fluororubber composition containing at least a peroxide vulcanizing agent, and in which the rubber layer (A) and the fluororubber layer (B) are stacked can be used to produce a laminate in which the rubber layer (A) is strongly bonded to the fluororubber layer (B).

### TECHNICAL FIELD

The present invention relates to a vulcanization bonding composition, a composition for a vulcanization-bonded laminate including the vulcanization bonding composition, and a laminate produced from the composition for a vulcanization-bonded laminate.

### BACKGROUND ART

Recently, increasing environmental awareness has advanced legislation to prevent fuel volatilization. Particularly in the automobile industry, mainly in the United States, there is a significant trend toward suppressing fuel volatilization, which has led to a growing need for materials with excellent fuel barrier properties. Widely used laminate hoses include a fluororesin as a barrier layer to provide good fuel barrier properties (rubber is used for the rest, other than the barrier layer). However, there is a concern that the fluororesin, which is poor in flexibility, may not be able to conform to the flexibility of the rubber laminated therewith, resulting in reduced adhesion. Most of such hoses are molded by steam vulcanization, and steam vulcanization is generally known to be inferior in adhesion to press vulcanization. Thus, an improvement in adhesion is desired for steam vulcanization. In addition to the evaporative control regulations, another problem is that the increasing use of alcohol-containing gasoline causes a failure in the bisphenol crosslinking system.

In this context, Patent Literature 1 provides a vulcanized rubber laminate produced by heating and bonding an unvulcanized epihalohydrin rubber composition layer and an unvulcanized fluororubber composition layer, wherein the unvulcanized epihalohydrin rubber composition contains a polyfunctional (meth)acrylate compound having two or more (meth)acryloyl groups in the molecule and a vulcanizing agent, and the unvulcanized fluororubber composition contains an organic peroxide vulcanizing agent. Patent Literatures 2 to 4 provide techniques for improving the adhesion to a fluororesin of a composition for a laminate that contains an epihalohydrin polymer and a vinyl group-containing compound, a diazabicyclo compound, an epoxy resin, and a metal salt hydrate. The epoxy resin and the metal salt hydrate are used as components for improving the adhesion to the fluororesin.

### CITATION LIST

### Patent Literature

Patent Literature 1: JP 5499713 B
Patent Literature 2: JP 6954272 B
Patent Literature 3: JP 5955222 B
Patent Literature 4: WO 2018/135367

### SUMMARY OF INVENTION

### Technical Problem

The present invention aims to provide a vulcanization bonding composition, a composition for a vulcanization-bonded laminate, and a laminate including the composition in which an epihalohydrin rubber can be strongly bonded to a fluororubber.

### Solution to Problem

As a result of various studies to achieve the aim, the present inventors have found the following. When a composition for a vulcanization-bonded laminate includes a rubber layer (A) formed from a vulcanization bonding composition at least containing (a1) an epihalohydrin rubber, (a2) a hydroxyl group-free tri- to penta-functional acrylate, (a3) an epoxy resin, (a4) nickel dibutyldithiocarbamate, and (a5) a vulcanizing agent, and a fluororubber layer (B) formed from a fluororubber composition containing at least a peroxide vulcanizing agent, and the rubber layer (A) and the fluororubber layer (B) are stacked, the composition for a vulcanization-bonded laminate can be vulcanized, even by steam vulcanization molding, which is known to be inferior in adhesion, to produce a laminate in which the rubber layer (A) is strongly bonded to the fluororubber layer (B). Accordingly, the present invention has been completed. Here, the use of steam vulcanization molding for vulcanization is believed to result in poor adhesion between the epihalohydrin rubber and the fluororubber due to the steam directly contacting the rubber.

Specifically, the present invention encompasses the following embodiments.

Embodiment 1. A vulcanization bonding composition, at least containing, per 100 parts by mass of (a1) an epihalohydrin rubber:
2 to 7 parts by mass of (a2) a hydroxyl group-free tri- to penta-functional acrylate;
0.5 to 3 parts by mass of (a3) an epoxy resin;
0.2 to 3 parts by mass of (a4) nickel dibutyldithiocarbamate; and
0.1 to 10 parts by mass of (a5) a vulcanizing agent.

Embodiment 2. The vulcanization bonding composition according to Embodiment 1,
wherein the (a1) epihalohydrin rubber is at least one selected from the group consisting of epihalohydrin-ethylene oxide copolymers, epihalohydrin-propylene oxide copolymers, epihalohydrin-allyl glycidyl ether copolymers, epihalohydrin-ethylene oxide-allyl glycidyl ether terpolymers, epihalohydrin-propylene oxide-allyl glycidyl ether terpolymers, and epihalohydrin-ethylene oxide-propylene oxide-allyl glycidyl ether quaternary copolymers.

Embodiment 3. The vulcanization bonding composition according to Embodiment 1 or 2,
wherein the (a2) hydroxyl group-free tri- to penta-functional acrylate is at least one selected from the group consisting of trimethylolpropane triacrylate, pentaerythritol tetraacrylate, and ditrimethylolpropane tetraacrylate.

Embodiment 4. The vulcanization bonding composition according to any one of Embodiments 1 to 3,
wherein the (a3) epoxy resin is a bisphenol A epoxy resin.

Embodiment 5. The vulcanization bonding composition according to any one of Embodiments 1 to 4,
wherein the (a5) vulcanizing agent is at least one selected from the group consisting of thiourea vulcanizing agents, quinoxaline vulcanizing agents, sulfur vulcanizing agents, peroxide vulcanizing agents, mercaptotriazine vulcanizing agents, and bisphenol vulcanizing agents.

Embodiment 6. A composition for a vulcanization-bonded laminate, including:
a rubber layer (A) formed from the vulcanization bonding composition according to any one of Embodiments 1 to 5; and
a fluororubber layer (B) formed from a fluororubber composition containing at least a peroxide vulcanizing agent,
wherein the rubber layer (A) and the fluororubber layer (B) are stacked.

Embodiment 7. A laminate, obtained by vulcanizing the composition for a vulcanization-bonded laminate according to Embodiment 6.

Embodiment 8. A tube or hose, including the laminate according to Embodiment 7.

### Advantageous Effects of Invention

The vulcanization bonding composition and composition for a vulcanization-bonded laminate of the present invention can provide a laminate with high adhesion even via steam vulcanization molding.

### DESCRIPTION OF EMBODIMENTS

### <Composition for Vulcanization-Bonded Laminate>

The composition for a vulcanization-bonded laminate of the present invention includes a layer (hereinafter, referred to as rubber layer (A)) formed from a vulcanization bonding composition at least containing an epihalohydrin rubber, a hydroxyl group-free tri- to penta-functional acrylate, an epoxy resin, nickel dibutyldithiocarbamate, and a vulcanizing agent, and a layer (hereinafter, referred to as fluororubber layer (B)) formed from a fluororubber composition containing at least a peroxide vulcanizing agent. Here, the expression “the composition for a vulcanization-bonded laminate includes the rubber layer (A) and the fluororubber layer (B)” typically means that the rubber layer (A) and the fluororubber layer (B) are stacked in the composition for a vulcanization-bonded laminate. It is sufficient that the composition for a vulcanization-bonded laminate includes the rubber layer (A) at least partially in contact with the fluororubber layer (B), and may include another layer in addition to the rubber layer (A) and the fluororubber layer (B).

The composition provides the above-described effect. The reason for this advantageous effect is not exactly clear but is believed to be as follows.

Generally, when an epihalohydrin rubber and a fluororubber layers are vulcanized, both layers are not compatible with each other on the bonding interface, resulting in no adhesion. To address this, a co-crosslinking agent may be added to both the epihalohydrin rubber and fluororubber layers for crosslinking to provide adhesion. Common co-crosslinking agents include polyfunctional acrylates such as pentaerythritol triacrylate and polyfunctional allyl compounds such as triallyl isocyanurate. These co-crosslinking agents can function as crosslinking points between the two rubber layers. However, when the co-crosslinking agent used is an acrylate having a hydroxy group in the molecule such as pentaerythritol triacrylate, if nickel dibutyldithiocarbamate, which is one of the most versatile antioxidants in the rubber field, is present in the rubber layer, radicals may be captured during the reaction between the co-crosslinking agent molecules at the bonding interface; moreover, the hydroxy group of pentaerythritol triacrylate may act as a chain transfer agent, likely resulting in reduced co-crosslinking agent ability. Therefore, when the co-crosslinking agent used is a hydroxy group-containing acrylate such as pentaerythritol triacrylate, nickel dibutyldithiocarbamate is not used or it is replaced by another antioxidant. In this case, however, there is concern about a reduction in heat resistance. In this regard, the present invention has found that a hydroxy group-free polyfunctional acrylate can be used to produce a composition for a vulcanization-bonded laminate which provides sufficient adhesion, even when nickel dibutyldithiocarbamate is used.

Moreover, a hydroxyl group-free tri- to penta-functional acrylate does not contain a hydroxy group which may capture and consume radicals. In addition, this acrylate is highly reactive due to the tri- or higher functionality, while the penta- or lower functionality can prevent too dense crosslinking. Then, when an epoxy resin is incorporated with the acrylate, the acrylate can be localized on the composition surface due to the compatibility among the epihalohydrin rubber, epoxy resin, and acrylate. Thus, the synergistic effect of the three components, i.e., the epihalohydrin rubber, the epoxy resin, and the hydroxyl group-free tri- to penta-functional acrylate allows the highly reactive tri- to penta-functional acrylate to be localized on the composition surface to provide strong adhesion to the fluororubber. It should be noted that this function is unique to the hydroxyl group-free tri- to penta-functional acrylate and, surprisingly, a hydroxy group-free tri- to penta-functional methacrylate does not provide such a function.

As described above, a vulcanization bonding composition containing (a1) an epihalohydrin rubber, (a2) a hydroxyl group-free tri- to penta-functional acrylate, (a3) an epoxy resin, (a4) nickel dibutyldithiocarbamate, and (a5) a vulcanizing agent provides strong adhesion to a fluororubber. Thus, a composition for a vulcanization-bonded laminate including a rubber layer (A) formed from the vulcanization bonding composition and a fluororubber layer (B) provides strong adhesion at the interface between the rubber layer (A) and the fluororubber layer (B). Therefore, the composition for a vulcanization-bonded laminate can be vulcanized even by steam vulcanization molding, which is known to be inferior in adhesion, to provide a laminate in which the rubber layer (A) is strongly bonded to the fluororubber layer (B). Thus, the vulcanization bonding composition and composition for a vulcanization-bonded laminate of the present invention can be suitably used in steam vulcanization applications.

Moreover, it is generally known that fluororubbers can be vulcanized by methods using peroxide vulcanizing agents or bisphenol vulcanizing agents, and that the methods using peroxide vulcanizing agents can result in weak adhesion between epihalohydrin rubbers and fluororubbers. Since the vulcanization bonding composition of the present invention provides strong adhesion to a fluororubber, it also provides good adhesion to a fluororubber composition containing a peroxide vulcanizing agent. Of course, it also provides strong adhesion to a fluororubber when a fluororubber composition containing a peroxide vulcanizing agent is used and vulcanization is performed by steam vulcanization molding.

### <Rubber Layer (A)>

The rubber layer (A) in the present invention is a layer formed from a vulcanization bonding composition at least containing (a1) an epihalohydrin rubber, (a2) a hydroxyl group-free tri- to penta-functional acrylate, (a3) an epoxy resin, (a4) nickel dibutyldithiocarbamate, and (a5) a vulcanizing agent.

The (a1) epihalohydrin rubber used in the present invention may be any binary or more copolymer containing a structural unit derived from an epihalohydrin and a structural unit derived from another component. For example, the structural unit derived from another component may include at least one selected from structural units derived from alkylene oxides such as ethylene oxide, propylene oxide, and n-butylene oxide and glycidyl compounds such as methyl glycidyl ether, ethyl glycidyl ether, n-glycidyl ether, allyl glycidyl ether, and phenyl glycidyl ether. More specific examples include epihalohydrin-ethylene oxide copolymers, epihalohydrin-propylene oxide copolymers, epihalohydrin-allyl glycidyl ether copolymers, epihalohydrin-ethylene oxide-allyl glycidyl ether terpolymers, epihalohydrin-propylene oxide-allyl glycidyl ether terpolymers, and epihalohydrin-ethylene oxide-propylene oxide-allyl glycidyl ether quaternary copolymers. Preferred among these are epihalohydrin-ethylene oxide copolymers, epihalohydrin-allyl glycidyl ether copolymers, and epihalohydrin-ethylene oxide-allyl glycidyl ether terpolymers, with epihalohydrin-allyl glycidyl ether copolymers and epihalohydrin-ethylene oxide-allyl glycidyl ether terpolymers being more preferred. These copolymers may be used alone or in combinations of two or more.

In view of heat resistance, the epihalohydrin rubber preferably contains a structural unit derived from an epihalohydrin in an amount of 10 mol % or more, more preferably 20 mol % or more, particularly preferably 25 mol % or more. The amount of the structural unit derived from an epihalohydrin can be calculated from the halogen atom (e.g., chlorine) content or other data. The halogen atom (e.g., chlorine) content can be determined by potentiometric titration in accordance with the method set forth in JIS K 7229.

In the case of an epihalohydrin-ethylene oxide copolymer, the lower limit of the amount of the structural unit derived from an epihalohydrin is preferably 10 mol % or more, more preferably 20 mol % or more, particularly preferably 25 mol % or more, while the upper limit is preferably 95 mol % or less, more preferably 75 mol % or less, particularly preferably 65 mol % or less. The lower limit of the amount of the structural unit derived from ethylene oxide is preferably 5 mol % or more, more preferably 25 mol % or more, particularly preferably 35 mol % or more, while the upper limit is preferably 90 mol %, more preferably 80 mol % or less, particularly preferably 75 mol % or less.

In the case of an epihalohydrin-ethylene oxide-allyl glycidyl ether terpolymer, the lower limit of the amount of the structural unit derived from an epihalohydrin is preferably 10 mol % or more, more preferably 20 mol % or more, particularly preferably 25 mol % or more, while the upper limit is preferably 95 mol % or less, more preferably 75 mol % or less, particularly preferably 65 mol % or less. The lower limit of the amount of the structural unit derived from ethylene oxide is preferably 4 mol % or more, more preferably 24 mol % or more, particularly preferably 34 mol % or more, while the upper limit is preferably 89 mol % or less, more preferably 79 mol % or less, particularly preferably 74 mol % or less. The lower limit of the amount of the structural unit derived from allyl glycidyl ether is preferably 1 mol % or more, while the upper limit is preferably 10 mol % or less, more preferably 8 mol % or less, particularly preferably 7 mol % or less.

The copolymerization composition of the epihalohydrin-ethylene oxide copolymer or epihalohydrin-ethylene oxide-allyl glycidyl ether terpolymer can be determined from the halogen atom (e.g., chlorine) content or iodine number. The halogen atom (e.g., chlorine) content is measured by potentiometric titration in accordance with the method set forth in JIS K 7229. The mole fraction of the structural unit based on an epihalohydrin is calculated from the determined halogen atom (e.g., chlorine) content. The iodine number is measured by a method in accordance with JIS K 6235. The mole fraction of the structural unit based on allyl glycidyl ether is calculated from the determined iodine number. The mole fraction of the structural unit based on ethylene oxide is calculated from the mole fraction of the structural unit based on an epihalohydrin and/or the mole fraction of the structural unit based on allyl glycidyl ether.

Examples of the epihalohydrin include epichlorohydrin and epibromohydrin, with epichlorohydrin being preferred.

Examples of the (a2) hydroxyl group-free tri- to penta-functional (preferably, tri- to tetra-functional) acrylate include trimethylolpropane triacrylate, ethoxylated trimethylolpropane triacrylate, propoxylated trimethylolpropane triacrylate, isocyanurate triacrylate, glycerol triacrylate, ethoxylated glycerol triacrylate, propoxylated glycerol triacrylate, pentaerythritol tetraacrylate, ethoxylated pentaerythritol tetraacrylate, propoxylated pentaerythritol tetraacrylate, ditrimethylolpropane tetraacrylate, ethoxylated ditrimethylolpropane tetraacrylate, and propoxylated ditrimethylolpropane tetraacrylate. Preferred among these are trimethylolpropane triacrylate, pentaerythritol tetraacrylate, and ditrimethylolpropane tetraacrylate, with trimethylolpropane triacrylate or pentaerythritol tetraacrylate being more preferred. These may be used alone or in combinations of two or more.

The lower limit of the amount of (a2) hydroxyl group-free tri- to penta-functional acrylates per 100 parts by mass of the amount of (a1) epihalohydrin rubbers in the vulcanization bonding composition is preferably 2 parts by mass or more, more preferably 3 parts by mass or more, still more preferably 4 parts by mass or more, while the upper limit is preferably 7 parts by mass or less, more preferably 6.5 parts by mass or less, still more preferably 6 parts by mass or less. When the amount is less than the lower limit, the acrylate can produce a small effect as a co-crosslinking agent to the fluororubber layer (B). When the amount is more than the upper limit, the crosslinking between the acrylate molecules can become dominant, and the acrylate can no longer function as a co-crosslinking agent.

The (a3) epoxy resin is preferably, for example, at least one resin selected from the group consisting of bisphenol A epoxy resins, bisphenol F epoxy resins, phenol novolac epoxy resins, o-cresol novolac epoxy resins, amine epoxy resins, hydrogenated bisphenol A epoxy resins, and polyfunctional epoxy resins. These may be used alone or in combinations of two or more. Of these, bisphenol A epoxy resins are preferred because they have good chemical resistance and good adhesion.

Also preferred are epoxy resins represented by the following formula (1). In formula (1), n represents an average value and it is preferably 0.1 to 3, more preferably 0.1 to 0.5, still more preferably 0.1 to 0.3.

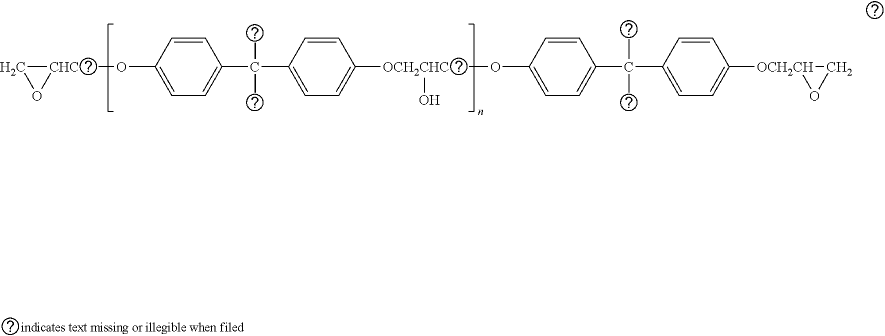

To further improve the adhesion to the fluororubber layer (B), the lower limit of the amount of (a3) epoxy resins per 100 parts by mass of the amount of (a1) epihalohydrin rubbers in the vulcanization bonding composition is preferably 0.3 parts by mass or more, more preferably 0.4 parts by mass or more, still more preferably 0.5 parts by mass or more, while the upper limit is preferably 3 parts by mass or less, more preferably 2.5 parts by mass or less, still more preferably 2 parts by mass or less.

The vulcanization bonding composition may contain (a4) nickel dibutyldithiocarbamate in any amount within the range where the (a4) nickel dibutyldithiocarbamate is usable as an antioxidant. The lower limit of the amount per 100 parts by mass of the amount of (a1) epihalohydrin rubbers is preferably 0.2 parts by mass or more, more preferably 0.3 parts by mass or more, still more preferably 0.5 parts by mass or more. The upper limit is preferably 3 parts by mass or less, more preferably 2 parts by mass or less, still more preferably 1.5 parts by mass or less.

The (a5) vulcanizing agent may be a vulcanizing agent commonly used in the rubber field and may be selected according to the intended use. Examples include polyamine vulcanizing agents, thiourea vulcanizing agents, thiadiazole vulcanizing agents, mercaptotriazine vulcanizing agents, pyrazine vulcanizing agents, quinoxaline vulcanizing agents, bisphenol vulcanizing agents, sulfur vulcanizing agents, peroxide vulcanizing agents, resin vulcanizing agents, and quinone dioxime vulcanizing agents. These may be used alone or in combinations of two or more.

Examples of the polyamine vulcanizing agents include ethylenediamine, hexamethylenediamine, diethylenetriamine, triethylenetetramine, hexamethylenetetramine, p-phenylenediamine, cumen diamine, N,N′-dicinnamylidene-1,6-hexanediamine, ethylenediamine carbamate, and hexamethylenediamine carbamate.

Examples of the thiourea vulcanizing agents include ethylene thiourea, 1,3-diethylthiourea, 1,3-dibutylthiourea, and trimethylthiourea.

Examples of the thiadiazole vulcanizing agents include 2,5-dimercapto-1,3,4-thiadiazole and 2-mercapto-1,3,4-thiadiazole-5-thiobenzoate.

Examples of the mercaptotriazine vulcanizing agents include 2,4,6-trimercapto-1,3,5-triazine, 2-methoxy-4,6-dimercaptotriazine, 2-hexylamino-4,6-dimercaptotriazine, 2-diethylamino-4,6-dimercaptotriazine, 2-cyclohexaneamino-4,6-dimercaptotriazine, 2-dibutylamino-4,6-dimercaptotriazine, 2-anilino-4,6-dimercaptotriazine, and 2-phenylamino-4,6-dimercaptotriazine.

Examples of the pyrazine vulcanizing agents include 2,3-dimercaptopyrazine derivatives. Examples of the 2,3-dimercaptopyrazine derivatives include pyrazine-2,3-dithiocarbonate, 5-methyl-2,3-dimercaptopyrazine, 5-ethylpyrazine-2,3-dithiocarbonate, 5,6-dimethyl-2,3-dimercaptopyrazine, and 5,6-dimethylpyrazine-2,3-dithiocarbonate.

Examples of the quinoxaline vulcanizing agents include 2,3-dimercaptoquinoxaline derivatives. Examples of the 2,3-dimercaptoquinoxaline derivatives include quinoxaline-2,3-dithiocarbonate, 6-methylquinoxaline-2,3-dithiocarbonate, 6-ethyl-2,3-dimercaptoquinoxaline, 6-isopropylquinoxaline-2,3-dithiocarbonate, and 5,8-dimethylquinoxaline-2,3-dithiocarbonate.

Examples of the bisphenol vulcanizing agents include 4,4′-dihydroxydiphenyl sulfoxide, 4,4′-dihydroxydiphenyl sulfone (bisphenol S), 1,1-cyclohexylidene-bis(4-hydroxybenzene), 2-chloro-1,4-cyclohexylene-bis(4-hydroxybenzene), 2,2-isopropylidene-bis(4-hydroxybenzene) (bisphenol A), hexafluoroisopropylidene-bis(4-hydroxybenzene) (bisphenol AF), and 2-fluoro-1,4-phenylene-bis(4-hydroxybenzene).

Examples of the sulfur vulcanizing agents include sulfur, morpholine disulfide, tetramethylthiuram disulfide, tetraethylthiuram disulfide, tetrabutylthiuram disulfide, N,N′-dimethyl-N, N′-diphenylthiuram disulfide, dipentanemethylenethiuram tetrasulfide, dipentamethylenethiuram tetrasulfide, and dipentamethylenethiuram hexasulfide.

Examples of the peroxide vulcanizing agents include tert-butyl hydroperoxide, p-menthane hydroperoxide, dicumyl peroxide, tert-butyl peroxide, 1,3-bis(tert-butylperoxyisopropyl)benzene, 2,5-dimethyl-2,5-di(tert-butylperoxy) hexane, benzoyl peroxide, and tert-butylperoxy benzoate.

Examples of the resin vulcanizing agents include alkylphenol formaldehyde resins.

Examples of the quinone dioxime vulcanizing agents include p-quinone dioxime and p-p′-dibenzoyl quinone dioxime.

The rubber layer (A) in the present invention preferably contains at least one vulcanizing agent selected from the group consisting of thiourea vulcanizing agents, quinoxaline vulcanizing agents, sulfur vulcanizing agents, peroxide vulcanizing agents, mercaptotriazine vulcanizing agents, and bisphenol vulcanizing agents, more preferably at least one vulcanizing agent selected from the group consisting of thiourea vulcanizing agents, quinoxaline vulcanizing agents, and bisphenol vulcanizing agents, particularly preferably a quinoxaline vulcanizing agent.

The lower limit of the amount of (a5) vulcanizing agents per 100 parts by mass of the amount of (a1) epihalohydrin rubbers in the vulcanization bonding composition is preferably 0.1 parts by mass or more, more preferably 0.3 parts by mass or more, still more preferably 0.5 parts by mass or more, particularly preferably 1 part by mass or more. The upper limit is preferably 10 parts by mass or less, more preferably 5 parts by mass or less, still more preferably 3 parts by mass or less.

A known vulcanization accelerator, a known vulcanization acceleration aid, or a known retarder may be used as it is together with the (a5) vulcanizing agent in the rubber layer (A) in the present invention. Examples of the vulcanization accelerator combined with the (a5) vulcanizing agent include primary, secondary, and tertiary amines and organic acid salts or adducts of these amines; various vulcanization accelerators such as diazabicyclo vulcanization accelerators, guanidine vulcanization accelerators, thiuram vulcanization accelerators, dithiocarbamate vulcanization accelerators, aldehyde ammonia vulcanization accelerators, aldehyde amine vulcanization accelerators, thiourea vulcanization accelerators, thiazole vulcanization accelerators, sulfenamide vulcanization accelerators, and xanthate vulcanization accelerators; vulcanization retarders such as N-nitrosodiphenylamine, phthalic anhydride, and N-cyclohexylthiophthalimide; vulcanization acceleration aids such as zinc oxide, stearic acid, and zinc stearate; and various crosslinking aids such as quinone dioxime crosslinking aids, methacrylate crosslinking aids, allyl crosslinking aids, and maleimide crosslinking aids. Moreover, examples of the retarder include N-cyclohexane thiophthalimide. These may be used alone or in combinations of two or more. Diazabicyclo vulcanization accelerators are preferred among these. Diazabicyclo vulcanization accelerators can promote the hydrolysis of the vulcanizing agent used and also can suppress the gelation of the (a2) highly reactive hydroxyl group-free tri- to penta-functional acrylate. Thus, when they are incorporated with the components (a1) to (a5), they can provide better adhesion.

Specific examples of the diazabicyclo vulcanization accelerators include 1,8-diazabicyclo(5.4.0) undecene-7 (DBU), 1,5-diazabicyclo(4.3.0) nonene-5, and 1,4-diazabicyclo(2.2.2) octane as well as their p-toluenesulfonic acid salts, phenol salts, phenolic resin salts, orthophthalic acid salts, formic acid salts, octylic acid salts, and naphthoic acid salts. In view of normal-state physical properties and heat resistance, 1,8-diazabicyclo(5.4.0) undecene-7 or phenolic resin salts or naphthoic acid salts of 1,8-diazabicyclo(5.4. 0) undecene-7 are preferred among these, with 1,8-diazabicyclo(5.4.0) undecene-7 or phenolic resin salts of 1,8-diazabicyclo(5.4. 0) undecene-7 being more preferred.

The amount of diazabicyclo vulcanization accelerators in the vulcanization bonding composition is preferably 0.1 to 10 parts by mass, more preferably 0.5 to 5 parts by mass, per 100 parts by mass of the amount of (a1) epihalohydrin rubbers.

The amount of vulcanization accelerators, vulcanization acceleration aids, crosslinking aids, and/or vulcanization retarders in the vulcanization bonding composition is preferably 0 to 10 parts by mass, more preferably 0.1 to 5 parts by mass, per 100 parts by mass of the amount of (a1) epihalohydrin rubbers.

Additionally, the rubber layer (A) in the present invention may contain any appropriate rubber such as acrylonitrile-butadiene rubbers (NBR), hydrogenated NBR (H-NBR), acrylic rubbers (ACM), ethylene acrylate rubbers (AEM), fluororubbers (FKM), chloroprene rubbers (CR), chlorosulfonated polyethylenes (CSM), chlorinated polyethylenes (CPE), and ethylene propylene rubbers (EPM, EPDM). These may be used alone or in combinations of two or more. The amount of these rubbers, if present, per 100 parts by mass of the amount of (a1) epihalohydrin rubbers is preferably 1 to 50 parts by mass.

The rubber layer (A) in the present invention may further contain an additional resin other than epoxy resins. Examples of such resins include poly(methyl methacrylate) (PMMA) resins, polystyrene (PS) resins, polyurethane (PUR) resins, poly(vinyl chloride) (PVC) resins, ethylene-vinyl acetate (EVA) resins, styrene-acrylonitrile (AS) resins, and polyethylene (PE) resins. These may be used alone or in combinations of two or more. The amount of these resins, if present, per 100 parts by mass of the amount of (a1) epihalohydrin rubbers is preferably 1 to 50 parts by mass.

Depending on the purpose or need, and as long as the advantageous effect of the present invention is not impaired, the rubber layer (A) in the present invention also may contain various additives which are usually contained in general rubber compositions. Examples of such additives include fillers, processing aids, plasticizers, acid acceptors, softeners, antioxidants, colorants, stabilizers, adhesion aids, release agents, conductivity-imparting agents, thermal conductivity-imparting agents, surface non-adhesive agents, tackifiers, flexibility-imparting agents, heat resistance improvers, flame retardants, ultraviolet absorbers, oil resistance improvers, foaming agents, antiscorching agents, and lubricants. The rubber layer (A) also may contain one or two or more common vulcanizing agents or vulcanization accelerators which are different from those described above. These may be used alone or in combinations of two or more.

Examples of the fillers include metal sulfides such as molybdenum disulfide, iron sulfide, and copper sulfide, diatomaceous earth, lithopone (zinc sulfide/barium sulfide), graphite, carbon black, silica, carbon fluoride, calcium fluoride, coke, quartz fine powder, talc, mica powder, wollastonite, carbon fibers, aramid fibers, various whiskers, glass fibers, organic reinforcing agents, and organic fillers. These fillers may be used alone or in combinations of two or more.

The lower limit of the amount of fillers per 100 parts by mass of the amount of (a1) epihalohydrin rubbers in the vulcanization bonding composition is preferably 5 parts by mass or more, more preferably 10 parts by mass or more, still more preferably 20 parts by mass or more. The upper limit is preferably 150 parts by mass or less, more preferably 100 parts by mass or less, still more preferably 75 parts by mass or less. Fillers in an amount outside the above range may adversely affect compression set.

Examples of the processing aids include higher fatty acids such as stearic acid, oleic acid, palmitic acid, and lauric acid; higher fatty acid salts such as sodium stearate and zinc stearate; higher fatty acid amides such as stearamide and oleamide; higher fatty acid esters such as ethyl oleate; higher aliphatic amines such as stearylamine and oleylamine; petroleum waxes such as carnauba wax and ceresin wax; polyglycols such as ethylene glycol, glycerol, and diethylene glycol; aliphatic hydrocarbons such as petrolatum and paraffin; silicone oils, silicone polymers, low molecular weight polyethylenes, phthalate esters, phosphate esters, rosins, (halogenated)dialkylamines, (halogenated)dialkyl sulfones, and surfactants. These may be used alone or in combinations of two or more.

The amount of processing aids per 100 parts by mass of the amount of (a1) epihalohydrin rubbers in the vulcanization bonding composition is preferably 1 part by mass to 10 parts by mass, more preferably 1.5 parts by mass to 7.5 parts by mass, still more preferably 2 parts by mass to 5 parts by mass.

Examples of the plasticizers include phthalic acid derivatives such as dioctyl phthalate (bis(2-ethylhexyl) phthalate) and diallyl phthalate; adipic acid derivatives such as dibutyl diglycol adipate and di(butoxyethoxy) ethyl adipate; sebacic acid derivatives such as dioctyl sebacate; and trimellitic acid derivatives such as trioctyl trimellitate. These may be used alone or in combinations of two or more.

The amount of plasticizers per 100 parts by mass of the amount of (a1) epihalohydrin rubbers in the vulcanization bonding composition is preferably 1 part by mass to 50 parts by mass, more preferably 1.5 parts by mass to 30 parts by mass, still more preferably 2 to 20 parts by mass.

In addition to (a4) nickel dibutyldithiocarbamate, the antioxidants may include known antioxidants. Examples of such known antioxidants include amine antioxidants, phenolic antioxidants, benzimidazole antioxidants, dithiocarbamate antioxidants, thiourea antioxidants, organic thioacid antioxidants, and phosphorus acid antioxidants. Preferred are dithiocarbamate antioxidants. These may be used alone or in combinations of two or more. Combinations of (a4) nickel dibutyldithiocarbamate with dithiocarbamate antioxidants (in particular, copper dimethyldithiocarbamate) other than (a4) nickel dibutyldithiocarbamate can provide better heat resistance and can also suppress the gelation of the (a2) highly reactive hydroxyl group-free tri- to penta-functional acrylate. Thus, when they are incorporated with the components (a1) to (a5), they can provide better adhesion.

Specific examples of the dithiocarbamate antioxidants include nickel diethyldithiocarbamate, nickel dimethyldithiocarbamate, nickel diisobutyldithiocarbamate, copper dimethyldithiocarbamate, copper diethyldithiocarbamate, copper dibutyldithiocarbamate, copper N-ethyl-N-phenyldithiocarbamate, copper N-pentamethylenedithiocarbamate, and copper dibenzyldithiocarbamate. Copper dimethyldithiocarbamate is preferred among these.

The amount of antioxidants (the amount excluding the amount of (a4) nickel dibutyldithiocarbamate, preferably the amount of dithiocarbamate antioxidants other than (a4) nickel dibutyldithiocarbamate) per 100 parts by mass of the amount of (a1) epihalohydrin rubbers in the vulcanization bonding composition is preferably 0.01 to 3 parts by mass, more preferably 0.05 to 2 parts by mass, still more preferably 0.075 to 1 part by mass.

Examples of the acid acceptors include metal compounds such as magnesium oxide, quick lime, zinc oxide, magnesium hydroxide, hydrated lime, barium hydroxide, calcium carbonate, magnesium carbonate, barium carbonate, calcium silicate, calcium stearate, zinc stearate, tin stearate, calcium phosphite, calcium phthalate, tin oxide, and basic tin phosphite, and synthetic hydrotalcites. The synthetic hydrotalcites refer to compounds represented by the formula: MgₓAl_{y}(OH)_{2x+3y-2}CO₃·WH₂O, where x represents a number of 1 to 10, y represents a number of 1 to 5, and w represents a real number. Specific examples of these compounds include Mg_{4.5}Al₂(OH)₁₃CO₃·3.5H₂O, Mg_{4.5}Al₂(OH)₁₃CO₃, Mg₄Al₂(OH)₁₂CO₃·3.5H₂O, Mg₆Al₂(OH)₁₆CO₃·4H₂O, Mg₅Al₂ (OH)₁₄CO₃·4H₂O, and Mg₃Al₂(OH)₁₀CO₃·1.7H₂O. These may be used alone or in combinations of two or more.

The amount of acid acceptors per 100 parts by mass of the amount of (a1) epihalohydrin rubbers in the vulcanization bonding composition is preferably 0.1 parts by mass to 20 parts by mass or less, more preferably 0.5 parts by mass to 15 parts by mass or less, still more preferably 1 part by mass to 10 parts by mass or less. Too large an amount of acid acceptors may excessively increase the hardness of the crosslinked rubber and may increase the Mooney viscosity of the vulcanization bonding composition, so that the compression set tends to decrease.

### <Fluororubber Layer (B)>

The fluororubber layer (B) used in the present invention is a layer formed from a fluororubber composition containing a fluororubber with at least a peroxide vulcanizing agent.

Examples of the fluororubber used in the present invention include vinylidene fluoride-hexafluoropropene binary copolymers, tetrafluoroethylene-hexafluoropropene binary copolymers, vinylidene fluoride-hexafluoropropene-tetrafluoroethylene terpolymers, vinylidene fluoride-perfluoroalkyl vinyl ether-tetrafluoroethylene terpolymers, tetrafluoroethylene-perfluoroethyl vinyl ether copolymers, and tetrafluoroethylene-perfluoropropyl vinyl ether copolymers. These may be used alone or in combinations of two or more. Preferred among these are vinylidene fluoride-hexafluoropropene binary copolymers, vinylidene fluoride-hexafluoropropene-tetrafluoroethylene terpolymers, and vinylidene fluoride-perfluoroalkyl vinyl ether-tetrafluoroethylene terpolymers, all of which contain vinylidene fluoride.

Examples of the peroxide vulcanizing agents include tert-butyl hydroperoxide, p-menthane hydroperoxide, dicumyl peroxide, tert-butyl peroxide, 1,3-bis(tert-butylperoxyisopropyl)benzene, 2,5-dimethyl-2,5-di(tert-butylperoxy) hexane, benzoyl peroxide, and tert-butylperoxy benzoate. These may be used alone or in combinations of two or more.

The lower limit of the amount of peroxide vulcanizing agents per 100 parts by mass of the amount of fluororubbers in the fluororubber composition is preferably 0.05 parts by mass or more, more preferably 1.0 parts by mass or more. The upper limit is preferably 10 parts by mass or less, more preferably 5 parts by mass or less. When the amount is less than the lower limit, the crosslinking of the fluororubber used may not sufficiently proceed, while when the amount is more than the upper limit, excessive crosslinking may occur, so that the hardness of the crosslinked product tends to increase.

The fluororubber layer (B) used in the present invention may contain a co-crosslinking agent. Examples include triallyl cyanurate, triallyl isocyanurate, triacrylformal, triallyl trimellitate, N,N′-m-phenylenebismaleimide, dipropargyl terephthalate, diallyl phthalate, tetraallyl terephthalamide, and triallyl phosphate. These may be used alone or in combinations of two or more. Of these, triallyl isocyanurate is preferred.

The lower limit of the amount of co-crosslinking agents per 100 parts by mass of the amount of fluororubbers in the fluororubber composition is preferably 0.1 parts by mass or more, more preferably 0.5 parts by mass or more. The upper limit is preferably 10 parts by mass or less, more preferably 5 parts by mass or less.

The fluororubber composition may contain various additives which are usually contained in fluororubber compositions, if necessary. Examples of such additives include fillers, processing aids, plasticizers, acid acceptors, softeners, antioxidants, colorants, stabilizers, adhesion aids, release agents, conductivity-imparting agents, thermal conductivity-imparting agents, surface non-adhesive agents, tackifiers, flexibility-imparting agents, heat resistance improvers, flame retardants, ultraviolet absorbers, oil resistance improvers, foaming agents, antiscorching agents, and lubricants. These may be used alone or in combinations of two or more.

The vulcanization bonding composition or the fluororubber composition may be compounded using any means conventionally used in the field of polymer processing, such as an open roll mill, a Banbury mixer, or any of various kneaders, for example.

The compounding may be carried out by a usual procedure used in the field of polymer processing. For example, the procedure may be carried out by first kneading only polymers and then introducing compounding agents other than a crosslinking agent and a crosslinking accelerator to prepare an A-kneaded compound, followed by introducing the crosslinking agent and the crosslinking accelerator to perform B-kneading.

### <Method for Producing Composition for Vulcanization-Bonded Laminate>

The method for producing a composition for a vulcanization-bonded laminate according to the present invention may include, for example, stacking the two rubber compositions (the vulcanization bonding composition and the fluororubber composition) by simultaneous extrusion or sequential extrusion. The method for producing a laminate according to the present invention may include vulcanizing the composition for a vulcanization-bonded laminate. For example, the two rubber compositions may be stacked by simultaneous extrusion or sequential extrusion to obtain a composition for a vulcanization-bonded laminate, which may then be subjected to heating and vulcanization or heating and vulcanization molding. Alternatively, for example, the two rubber compositions may be subjected to simultaneous stacking and heating and vulcanization molding using a mold. Another applicable method includes heating and fluidizing one of the two rubber compositions at a temperature not causing a vulcanization reaction, followed by stacking the two rubber compositions and subjecting the stack to sufficient heating and vulcanization molding. The unvulcanized stack (composition for a vulcanization-bonded laminate) stacked by extrusion as above may be subjected to heating and vulcanization molding by any known method, such as using a steam can, an air bath, infrared rays, or microwaves for a heating and vulcanization method, or by lead vulcanization. In the vulcanization, the heating temperature is usually 100° C. to 200° C., and the heating time is selected from 0.5 to 300 minutes, depending on the temperature. As described above, the vulcanization bonding composition and composition for a vulcanization-bonded laminate of the present invention can be suitably used in steam vulcanization applications. In steam vulcanization, in particular, they can significantly provide strong adhesion between the epihalohydrin rubber and the fluororubber. Therefore, the laminate of the present invention is preferably produced by subjecting the vulcanization bonding composition or composition for a vulcanization-bonded laminate of the present invention to steam vulcanization.

Preferably, the laminate of the present invention includes a crosslinked product of the fluororubber composition as an inner layer and a crosslinked product of the vulcanization bonding composition as an outer layer in order to have excellent physical properties. To take the advantage of the good adhesion of the vulcanization bonding composition to the fluororubber composition, the crosslinked product of the fluororubber composition as an inner layer is preferably at least partially in contact with the crosslinked product of the vulcanization bonding composition as an outer layer.

The laminate of the present invention exhibits sufficient adhesion even when exposed to harsh conditions (e.g., immersion in fuel oil) because chemically strong adhesion is obtained during crosslinking without requiring any complicated step in the lamination of the crosslinked product of the vulcanization bonding composition and the crosslinked product of the fluororubber composition. Moreover, the laminate can be easily formed at low cost and also has good formability. Moreover, as the laminate can be formed by an ordinary method such as extrusion, it can also be made thinner and have excellent flexibility as well. Therefore, the laminate of the present invention can be suitably used as a tube or hose including the laminate of the present invention.

Typical examples of embodiments in which the laminate of the present invention is used in, for example, a fuel oil hose include a two-layer hose including the fluororubber (B) as an inner layer and the rubber layer (A) as an outer layer of the hose, a three-layer hose including a braided reinforcement layer on the outer side of the two-layer hose, and a four-layer hose further including a rubber layer on the outer side of the three-layer hose. The braided material used in the three-layer or four-layer hose or the like is usually made of braided polyester fibers, polyamide fibers, glass fibers, vinylon fibers, cotton, or other materials. Moreover, the material of the outermost layer used in the four-layer hose is usually a synthetic rubber with properties such as aging resistance, weather resistance, and/or oil resistance, examples of which include epihalohydrin-based rubbers, as well as ethylene-acrylate rubbers, chloroprene rubbers, chlorinated polyethylene rubbers, and chlorosulfonated polyethylenes.

The composition for a vulcanization-bonded laminate according to the present invention obtained as above can provide very excellent adhesion between the two vulcanized rubbers and a strong bonding surface. Therefore, it is extremely effective in applications where one surface is exposed to an environment requiring resistance to rancid gasoline, resistance to gasoline permeation, resistance to alcohol-containing gasoline, or the like, and the other surface is exposed to an environment requiring aging resistance, weather resistance, gasoline resistance, or the like, such as fuel hoses, filler hoses, etc.

### EXAMPLES

Examples are described as typical examples below, but the present invention is not limited to the examples.

The compounding agents used in the examples and comparative examples are listed below.
1 “EPICHLOMER CG-105” available from Osaka Soda Co., Ltd.
2 “EPICHLOMER C55” available from Osaka Soda Co., Ltd.
3 “Seast SO” available from Tokai Carbon Co., Ltd.
4 “ADEKA CIZER RS-107” available from ADEKA CORPORATION
5 “SPLENDER R-300” available from Kao Corporation
6 “STABIACE HT-1” available from Sakai Chemical Industry Co., Ltd.
7 “KYOWAMAG #150” available from Kyowa Chemical Industry Co., Ltd.
8 “P-152” available from Osaka Soda Co., Ltd.
9 “NOCCELER TTCu” available from Ouchi Shinko Chemical Industrial Co., Ltd.
10 “NOCRAC NBC” available from Ouchi Shinko Chemical Industrial Co., Ltd.
11 “Light acrylate TMP-A” available from Kyoeisha Chemical Co., Ltd.
12 “M420” available from MIWON
13 “DS CIZER MMK-08” available from Osaka Soda Co., Ltd.
14 “LIGHT ESTER TMP” available from Kyoeisha Chemical Co., Ltd.
15 “ARONIX M-402” available from Toagosei Co., Ltd.
16 “JER828” available from Mitsubishi Chemical Corporation
17 “Retarder CTP” available from Ouchi Shinko Chemical Industrial Co., Ltd.
18 “DAISONET XL21-S” available from Osaka Soda Co., Ltd.
19 “DAI-EL G-8002” available from Daikin Industries, Ltd.
20 “Thermax N990” available from Cancarb
21 “Triallyl isocyanurate” available from Tokyo Chemical Industry Co., Ltd.
22 “Perhexa 25B” available from NOF Corporation

### Example 1

Compounding was performed as shown in Table 1, and parts by mass of an epichlorohydrin-ethylene oxide-allyl glycidyl ether terpolymer, 50 parts by mass of carbon black N550, 10 parts by mass of an adipic acid ether ester compound, 3 parts by mass of an ester wax (fatty acid ester), 3 parts by mass of a synthetic hydrotalcite, 3 parts by mass of magnesium oxide, 1 part by mass of a DBU phenolic resin salt, 0.1 parts by mass of copper dimethyldithiocarbamate, 1 part by mass of nickel dibutyldithiocarbamate, and 5 parts by mass of trimethylolpropane triacrylate were added and kneaded in a 1.67-L Banbury mixer at 100° C. to prepare an A-kneaded compound. Thereafter, 1 part by mass of a bisphenol A epoxy resin, 0.5 parts by mass of N-cyclohexylthiophthalimide, and 1.7 parts by mass of a quinoxaline vulcanizing agent were added to the A-kneaded compound, and they were kneaded at room temperature using a kneading roll to obtain a B-kneaded compound having a thickness of 2.0 to 2.5 mm as a rubber layer (A). Separately, as shown in Table 2, 100 parts by mass of a fluororubber, 20 parts by mass of carbon black N990, and 3 parts by mass of triallyl isocyanurate were added and kneaded in a 1-L kneader at 60° C. Then, 2.5 parts by mass of 2,5-dimethyl-2,5-di(tert-butylperoxy) hexane was added to the kneaded mixture, and they were kneaded at room temperature using a kneading roll to obtain a fluororubber layer (B) having a thickness of 2.0 to 2.5 mm. The rubber layer (A) and the fluororubber layer (B) were attached to each other and then vulcanized in a vulcanizer at 0.52 MPa (160° C.) for 30 minutes (steam vulcanization molding) to obtain a primary vulcanized laminate having a thickness of 4.0 to 5.0 mm. The primary vulcanized laminate was then vulcanized at 160° C. for two hours (steam vulcanization molding) to obtain a secondary vulcanized laminate.

### (Evaluation of Adhesion (180° Peeling Test))

The secondary vulcanized laminate was cut into a 2.5×10 cm strip to prepare an adhesion test specimen. The specimen was subjected to a 180° peeling test in accordance with JIS K 6256-1 using Strograph E3 available from Toyo Seiki at a temperature of 23° C. and a tensile rate of 50 mm/min, and then the peeling state was visually observed. Table 3 shows the results. The evaluation criteria are as follows.
Good: The layers are strongly bonded to each other, and rubber fracture occurs between the layers.
Fair: Although the layers are bonded to each other, the peel strength is weak and partial rubber fracture occurs or peeling occurs at the interface.
Poor: The layers are not at all bonded to each other, and peeling occurs at the interface.

Further, the average of the peel strengths measured at 0 to 100 mm in the peeling test was calculated. If the material broke during the measurement, the measurement was stopped at that point and the average of the peel strengths measured up to that point was calculated. Each specimen was tested three times, and the median value of the measured peel strengths was used for evaluation. The results are also shown in Table 3.

### Example 2

Example 2 was performed as in Example 1 to obtain a secondary vulcanized laminate, except that compounding was performed as shown in Table 1, the trimethylolpropane triacrylate was changed to pentaerythritol tetraacrylate. The adhesion was evaluated as described above.

### Example 3

Example 3 was performed as in Example 1 to obtain a secondary vulcanized laminate, except that compounding was performed as shown in Table 1 and the epichlorohydrin-ethylene oxide-allyl glycidyl ether terpolymer was changed to an epichlorohydrin-ethylene oxide copolymer. The adhesion was evaluated as described above.

### Comparative Example 1

Comparative Example 1 was performed as in Example 1 to obtain a secondary vulcanized laminate, except that compounding was performed as shown in Table 1 and the bisphenol A epoxy resin was not incorporated. The adhesion was evaluated as described above.

### Comparative Example 2

Comparative Example 2 was performed as in Example 1 to obtain a secondary vulcanized laminate, except that compounding was performed as shown in Table 1 and the nickel dibutyldithiocarbamate was not incorporated. The adhesion was evaluated as described above.

### Comparative Example 3

Comparative Example 3 was performed as in Example 1 to obtain a secondary vulcanized laminate, except that compounding was performed as shown in Table 1 and the bisphenol A epoxy resin and the nickel dibutyldithiocarbamate were not incorporated. The adhesion was evaluated as described above.

### Comparative Example 4

Comparative Example 4 was performed as in Example 1 to obtain a secondary vulcanized laminate, except that compounding was performed as shown in Table 1 and the trimethylolpropane triacrylate was changed to trimethylolpropane trimethacrylate. The adhesion was evaluated as described above.

### Comparative Example 5

Comparative Example 5 was performed as in Example 1 to obtain a secondary vulcanized laminate, except that compounding was performed as shown in Table 1 and the trimethylolpropane triacrylate was changed to dipentaerythritol hexaacrylate. The adhesion was evaluated as described above.

### Comparative Example 6

Comparative Example 6 was performed as in Example 3 to obtain a secondary vulcanized laminate, except that compounding was performed as shown in Table 1 and the trimethylolpropane triacrylate was not incorporated. The adhesion was evaluated as described above.

### Comparative Example 7

Comparative Example 7 was performed as in Example 3 to obtain a secondary vulcanized laminate, except that compounding was performed as shown in Table 1 and the trimethylolpropane triacrylate was changed to pentaerythritol triacrylate. The adhesion was evaluated as described above.

### Comparative Example 8

Comparative Example 8 was performed as in Example 3 to obtain a secondary vulcanized laminate, except that compounding was performed as shown in Table 1 and the trimethylolpropane triacrylate was changed to pentaerythritol triacrylate, and the nickel dibutyldithiocarbamate and the bisphenol A epoxy resin were not incorporated. The adhesion was evaluated as described above.

TABLE 1

| | | | | | | Comp. | Comp. | Comp. |
|---|---|---|---|---|---|---|---|---|
| | | | Ex. 1 | Ex. 2 | Ex. 3 | Ex. 1 | Ex. 2 | Ex. 3 |
| A-kneading | Epichlorohydrin-ethylene oxide-allyl glycidyl | (parts by mass) | 100 | 100 | | 100 | 100 | 100 |
| | ether terpolymer *1 | | | | | | | |
| | Epichlorohydrin-ethylene oxide copolymer *2 | (parts by mass) | | | 100 | | | |
| | Carbon black N550 *3 | (parts by mass) | 50 | 50 | 50 | 50 | 50 | 50 |
| | Adipic acid ether ester compound *4 | (parts by mass) | 10 | 10 | 10 | 10 | 10 | 10 |
| | Fatty acid ester *5 | (parts by mass) | 3 | 3 | 3 | 3 | 3 | 3 |
| | Synthetic hydrotalcite *6 | (parts by mass) | 3 | 3 | 3 | 3 | 3 | 3 |
| | Magnesium oxide *7 | (parts by mass) | 3 | 3 | 3 | 3 | 3 | 3 |
| | DBU phenolic resin salt *8 | (parts by mass) | 1 | 1 | 1 | 1 | 1 | 1 |
| | Copper dimethyldithiocarbamate *9 | (parts by mass) | 0.1 | 0.1 | 0.1 | 0.1 | 0.1 | 0.1 |
| | Nickel dibutyldithiocarbamate *10 | (parts by mass) | 1 | 1 | 1 | 1 | | |
| | Trimethylolpropane triacrylate *11 | (parts by mass) | 5 | | 5 | 5 | 5 | 5 |
| | Pentaerythritol tetraacrylate *12 | (parts by mass) | | 5 | | | | |
| | Pentaerythritol triacrylate *13 | (parts by mass) | | | | | | |
| | Trimethylolpropane trimethacrylate *14 | (parts by mass) | | | | | | |
| | Dipentaerythritol hexaacrylate *15 | (parts by mass) | | | | | | |
| B-kneading | Bisphenol A epoxy resin *16 | (parts by mass) | 1 | 1 | 1 | | 1 | |
| | N-cyclohexylthiophthalimide *17 | (parts by mass) | 0.5 | 0.5 | 0.5 | 0.5 | 0.5 | 0.5 |
| | Quinoxaline vulcanizing agent *18 | (parts by mass) | 1.7 | 1.7 | 1.7 | 1.7 | 1.7 | 1.7 |

| | | | Comp. | Comp. | Comp. | Comp. | Comp. |
|---|---|---|---|---|---|---|---|
| | | | Ex. 4 | Ex. 5 | Ex. 6 | Ex. 7 | Ex. 8 |
| A-kneading | Epichlorohydrin-ethylene oxide-allyl glycidyl | (parts by mass) | 100 | 100 | | | |
| | ether terpolymer *1 | | | | | | |
| | Epichlorohydrin-ethylene oxide copolymer *2 | (parts by mass) | | | 100 | 100 | 100 |
| | Carbon black N550 *3 | (parts by mass) | 50 | 50 | 50 | 50 | 50 |
| | Adipic acid ether ester compound *4 | (parts by mass) | 10 | 10 | 10 | 10 | 10 |
| | Fatty acid ester *5 | (parts by mass) | 3 | 3 | 3 | 3 | 3 |
| | Synthetic hydrotalcite *6 | (parts by mass) | 3 | 3 | 3 | 3 | 3 |
| | Magnesium oxide *7 | (parts by mass) | 3 | 3 | 3 | 3 | 3 |
| | DBU phenolic resin salt *8 | (parts by mass) | 1 | 1 | 1 | 1 | 1 |
| | Copper dimethyldithiocarbamate *9 | (parts by mass) | 0.1 | 0.1 | 0.1 | 0.1 | 0.1 |
| | Nickel dibutyldithiocarbamate *10 | (parts by mass) | 1 | 1 | 1 | 1 | |
| | Trimethylolpropane triacrylate *11 | (parts by mass) | | | | | |
| | Pentaerythritol tetraacrylate *12 | (parts by mass) | | | | | |
| | Pentaerythritol triacrylate *13 | (parts by mass) | | | | 5 | 5 |
| | Trimethylolpropane trimethacrylate *14 | (parts by mass) | 5 | | | | |
| | Dipentaerythritol hexaacrylate *15 | (parts by mass) | | 5 | | | |
| B-kneading | Bisphenol A epoxy resin *16 | (parts by mass) | 1 | 1 | 1 | 1 | |
| | N-cyclohexylthiophthalimide *17 | (parts by mass) | 0.5 | 0.5 | 0.5 | 0.5 | 0.5 |
| | Quinoxaline vulcanizing agent *18 | (parts by mass) | 1.7 | 1.7 | 1.7 | 1.7 | 1.7 |

Ex.: Example
Comp. Ex.: Comparative Example

TABLE 2

| | parts by mass |
|---|---|
| Fluororubber *19 | 100 |
| Carbon black N990 *20 | 20 |
| Triallyl isocyanurate *21 | 3 |
| 2,5-Dimethyl-2,5-di(tert-butylperoxy) hexane *22 | 2.5 |

TABLE 3

| | | | | Comp. | Comp. | Comp. | Comp. | Comp. | Comp. | Comp. | Comp. |
|---|---|---|---|---|---|---|---|---|---|---|---|
| | Ex. 1 | Ex. 2 | Ex. 3 | Ex. 1 | Ex. 2 | Ex. 3 | Ex. 4 | Ex. 5 | Ex. 6 | Ex. 7 | Ex. 8 |
| Peeling state | Good | Good | Good | Fair | Poor | Poor | Poor | Fair | Poor | Poor | Fair |
| Peel strength | 3.2 | 4.1 | 3.0 | 2.4 | Less | Less | 2.1 | 2.1 | Less | Less | 2.4 |
| (kN/m) | | | | | than | than | | | than | than | |
| | | | | | 1.0 | 1.0 | | | 1.0 | 1.0 | |

As can be demonstrated in Table 3, the laminates prepared from the compositions for a vulcanization-bonded laminate of the examples exhibited strong adhesion in the 180° peeling test compared to the laminates prepared from the compositions for a vulcanization-bonded laminate of the comparative examples. The results also show that the use of a polyfunctional acrylate having too many functional groups conversely reduces adhesion.

### INDUSTRIAL APPLICABILITY

The laminate according to the present invention has very excellent adhesion between the two vulcanized rubbers and a strong bonding surface. Therefore, it is extremely effective in applications where one surface is exposed to an environment requiring resistance to rancid gasoline, resistance to gasoline permeation, resistance to alcohol-containing gasoline, or the like, and the other surface is exposed to an environment requiring aging resistance, weather resistance, gasoline resistance, or the like, such as fuel hoses, filler hoses, etc.

1. A vulcanization bonding composition, at least comprising, per 100 parts by mass of (a1) an epihalohydrin rubber:
2 to 7 parts by mass of (a2) a hydroxyl group-free tri- to penta-functional acrylate;
0.5 to 3 parts by mass of (a3) an epoxy resin;
0.2 to 3 parts by mass of (a4) nickel dibutyldithiocarbamate; and
0.1 to 10 parts by mass of (a5) a vulcanizing agent.

2. The vulcanization bonding composition according to claim 1,
wherein the (a1) epihalohydrin rubber is at least one selected from the group consisting of epihalohydrin-ethylene oxide copolymers, epihalohydrin-propylene oxide copolymers, epihalohydrin-allyl glycidyl ether copolymers, epihalohydrin-ethylene oxide-allyl glycidyl ether terpolymers, epihalohydrin-propylene oxide-allyl glycidyl ether terpolymers, and epihalohydrin-ethylene oxide-propylene oxide-allyl glycidyl ether quaternary copolymers.

3. The vulcanization bonding composition according to claim 1,
wherein the (a2) hydroxyl group-free tri- to penta-functional acrylate is at least one selected from the group consisting of trimethylolpropane triacrylate, pentaerythritol tetraacrylate, and ditrimethylolpropane tetraacrylate.

4. The vulcanization bonding composition according to claim 1,
wherein the (a3) epoxy resin is a bisphenol A epoxy resin.

5. The vulcanization bonding composition according to claim 1,
wherein the (a5) vulcanizing agent is at least one vulcanizing agent selected from the group consisting of thiourea vulcanizing agents, quinoxaline vulcanizing agents, sulfur vulcanizing agents, peroxide vulcanizing agents, mercaptotriazine vulcanizing agents, and bisphenol vulcanizing agents.

6. A composition for a vulcanization-bonded laminate, comprising:
a rubber layer (A) formed from the vulcanization bonding composition according to claim 1; and
a fluororubber layer (B) formed from a fluororubber composition comprising at least a peroxide vulcanizing agent,
wherein the rubber layer (A) and the fluororubber layer (B) are stacked.

7. A laminate, obtained by vulcanizing the composition for a vulcanization-bonded laminate according to claim 6.

8. A tube or hose, comprising the laminate according to claim 7.
